(19) United States
(12) Patent Application Publication
(10) Pub. No.: US 2012/0062763 A1
(43) Pub. Date: Mar. 15, 2012

(54) IMAGE PROCESSING APPARATUS, IMAGE PROCESSING METHOD, AND CAMERA MODULE

(75) Inventors: Shiroshi KANEMITSU, Kanagawa (JP); Kenichi ARAKAWA, Kanagawa (JP); Kazuhiro TABUCHI, Kanagawa (JP); Takaaki KAWAKAMI, Kanagawa (JP)

(73) Assignee: KABUSHIKI KAISHA TOSHIBA, Tokyo (JP)

(21) Appl. No.: 13/187,794

(22) Filed: Jul. 21, 2011

(30) Foreign Application Priority Data
Sep. 10, 2010 (JP) 2010-202945

(51) Int. Cl. H04N 9/73; G06K 9/00

(52) U.S. Cl. 348/223.1; 382/167; 348/E09.051

(57) ABSTRACT

According to one embodiment, an image processing apparatus includes a color mixture correction unit. The color mixture correction unit corrects the mixture of colors caused when an incident light having passed through color filters corresponding to neighboring pixels enters a target pixel. The color mixture correction unit references the signal level of the target pixel and the signal levels of the neighboring pixels. The color mixture correction unit calculates a correction amount corresponding to the signal level of a red pixel which is the neighboring pixel. The color mixture correction unit performs a calculation on the signal level of the target pixel using the correction amount.

### CROSS-REFERENCE TO RELATED APPLICATIONS

This application is based upon and claims the benefit of priority from the prior Japanese Patent Application No. 2010-202945, filed on Sep. 10, 2010; the entire contents of all of which are incorporated herein by reference.

### FIELD

Embodiments described herein relate generally to an image processing apparatus, an image processing method, and a camera module.

### BACKGROUND

In a solid-state imaging device such as a complementary metal oxide semiconductor (CMOS) sensor, when a single-chip sensor is configured using a general-use P-type silicon substrate, a phenomenon called mixture of colors may occur. The mixture of colors occurs when light having passed through a color filter enters a pixel other than a target pixel where the light is to be focused originally. The occurrence of the mixture of colors may decrease color reproduction, resolution, and the like. Moreover, when pixels of respective colors are arranged in the Bayer arrangement, for example, the signal level output from a green pixel neighboring a red pixel may differ from the signal level output from a green pixel neighboring a blue pixel due to the effect of color mixture. An image signal in which the pixels of the same color have different output signal levels may produce a grid-like noise pattern when it is subjected to image processing such as demosaic processing. In this respect, it is desirable to suppress the effect of color mixture effectively.

### BRIEF DESCRIPTION OF THE DRAWINGS

FIG. 1 is a block diagram of a camera module to which an image processing apparatus according to a first embodiment is applied;

FIG. 2 is a block diagram showing a schematic configuration of a digital camera with the camera module shown in FIG. 1;

FIG. 3 is a block diagram showing a configuration of a color mixture correction unit;

FIG. 4 is a diagram illustrating the arrangement of pixels;

FIG. 5 is a diagram illustrating mixture of colors;

FIG. 6 is a block diagram showing a configuration of a color mixture correction unit used in an image processing apparatus according to a second embodiment;

FIG. 7 is a block diagram showing a configuration of a color mixture correction unit and a low-pass filter which are used in an image processing apparatus according to a third embodiment.

### DETAILED DESCRIPTION

In general, according to one embodiment, an image processing apparatus includes a color mixture correction unit. The color mixture correction unit corrects the mixture of colors caused when an incident light having passed through color filters corresponding to neighboring pixels enters a target pixel. The target pixel and the neighboring pixels are pixels arranged in a solid-state imaging device. The neighboring pixels are disposed around the target pixel. The color mixture correction unit references a signal level of the target pixel and signal levels of the neighboring pixels. The color mixture correction unit calculates a correction amount corresponding to the signal level of a red pixel which is the neighboring pixel. The color mixture correction unit performs a calculation on the signal level of the target pixel using the correction amount.

Exemplary embodiments of an image processing apparatus, an image processing method, and a camera module will be explained below in detail with reference to the accompanying drawings. The present invention is not limited to the following embodiments.

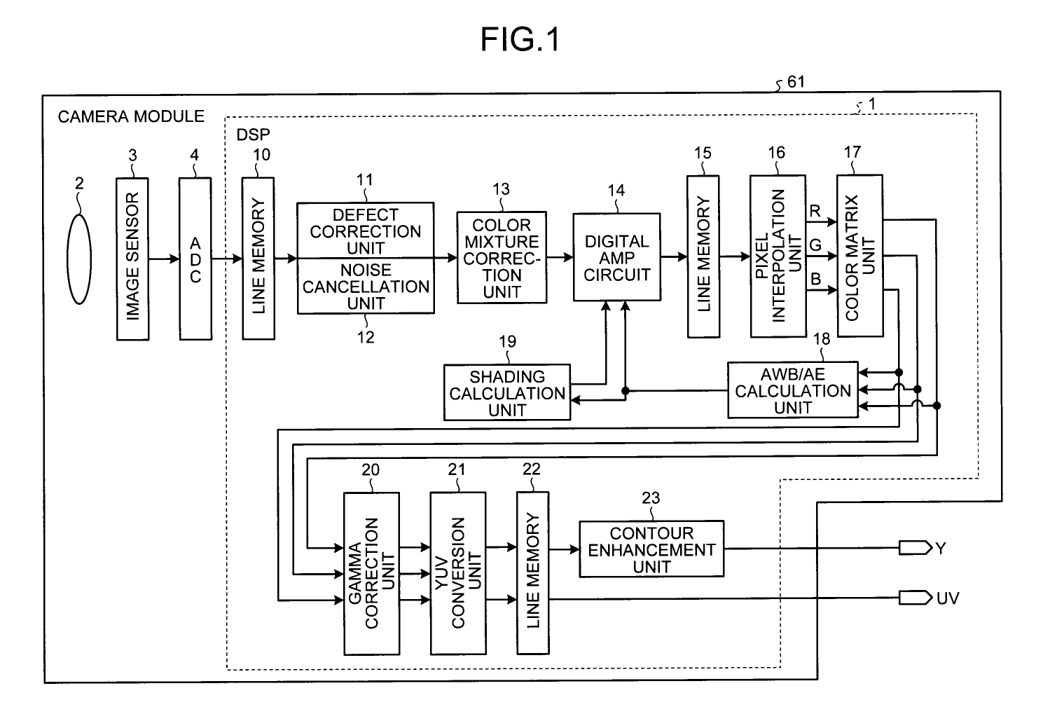

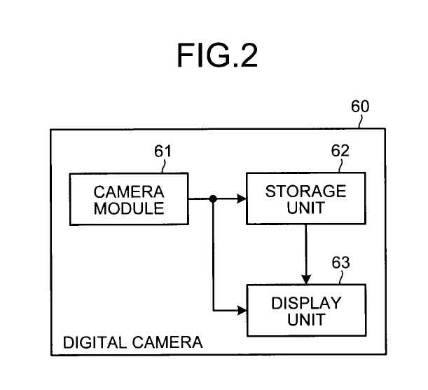

FIG. 1 is a block diagram of a camera module to which an image processing apparatus according to a first embodiment is applied. FIG. 2 is a block diagram showing a schematic configuration of a digital camera with the camera module shown in FIG. 1.

A digital camera 60 includes a camera module 61, a storage unit 62, and a display unit 63. The camera module 61 images a subject image. The storage unit 62 stores an image captured by the camera module 61. The display unit 63 displays an image captured by the camera module 61. The display unit 63 is a liquid crystal display, for example.

The camera module 61 outputs an image signal to the storage unit 62 and the display unit 63 when the subject is captured. The storage unit 62 outputs an image signal to the display unit 63 in accordance with an operation of the user, or the like. The display unit 63 displays an image in accordance with an image signal input from the camera module 61 or the storage unit 62.

The camera module 61 includes a lens unit 2, an image sensor 3, an analog-to-digital converter (ADC) 4, and a digital signal processor (DSP) 1.

The lens unit 2 captures light from a subject and causes the subject image to be imaged by the image sensor 3. The image sensor 3 is a solid-state imaging device that converts the light captured by the lens unit 2 into signal charge in order to image the subject image.

The image sensor 3 includes a color filter stacked on each pixel cell including a photoelectric conversion device. An R pixel refers to a pixel in which a color filter transmitting red (R) light is stacked. A G pixel refers to a pixel in which a color filter transmitting green (G) light is stacked. A B pixel refers to a pixel in which a color filter transmitting blue (B) light is stacked.

The image sensor 3 captures the signal values of the colors R, G, and B in the order corresponding to the Bayer arrangement, thereby generating an analog image signal. The ADC 4 converts the format of the image signal received from the image sensor 3, from an analog format into a digital format.

The DSP 1 which is an image processing apparatus performs various image processes on the digital image signal received from the ADC 4. A line memory 10 provided in the DSP 1 temporarily stores the digital image signal received from the ADC 4. A defect correction unit 11 and a noise cancellation unit 12 share the line memory 10.

The defect correction unit 11 performs defect correction with respect to a digital image signal received from the line memory 10. That is, the defect correction unit 11 corrects a lost portion (defect) of the digital image signal attributable to a malfunctioning pixel in the image sensor 3.

The noise cancellation unit 12 performs a noise canceling process for noise reduction. A shading calculation unit 19 calculates a shading correction coefficient for shading correction. The color mixture correction unit 13 performs color mixture correction.

A digital amplification (AMP) circuit 14 calculates a digital AMP coefficient on the basis of the coefficient calculated by an AWB/AE calculation section 18 and the shading correction coefficient calculated by the shading calculation section 19. Moreover, the digital AMP circuit 14 multiplies the digital image signal having passed through the color mixture correction by the color mixture correction unit 13 by the digital AMP coefficient.

The line memory 15 temporarily stores the digital image signal which is multiplied by the digital AMP coefficient. A pixel interpolation unit 16 generates RGB sensitivity signals by performing interpolaton (demosaic processing) on the digital image signals which are transferred from the line memory 15 in the order of the Bayer arrangement. A color matrix unit 17 performs a color matrix calculation process (color-reproduction process) for obtaining color reproduction on the RGB sensitivity signals.

The AWB/AE calculation unit 18 calculates respective coefficients for use in auto-white balance (AWB) adjustment and auto-exposure (AE) adjustment on the basis of the RGB sensitivity signals.

A gamma correction unit 20 performs gamma correction for correcting the gradation of an image with respect to the RGB sensitivity signals. A YUV conversion unit 21 generates a luminance (Y) signal and a color difference (UV) signal from the RGB sensitivity signals to thereby convert the format of an image signal from RGB to YUV (for example, YUV422 or the like). A line memory 22 temporarily stores the Y signal and the UV signal received from the YUV conversion unit 21.

A contour enhancement unit 23 performs contour enhancement processing on the Y signal read from the line memory 22. The contour enhancement unit 23 performs contour enhancement processing using the correction coefficients calculated based on the imaging conditions of the image sensor 3 and the positions of the respective pixels. The DSP 1 outputs the Y signal which has been subjected to the contour enhancement processing in the contour enhancement unit 23 and the UV signal read from the line memory 22.

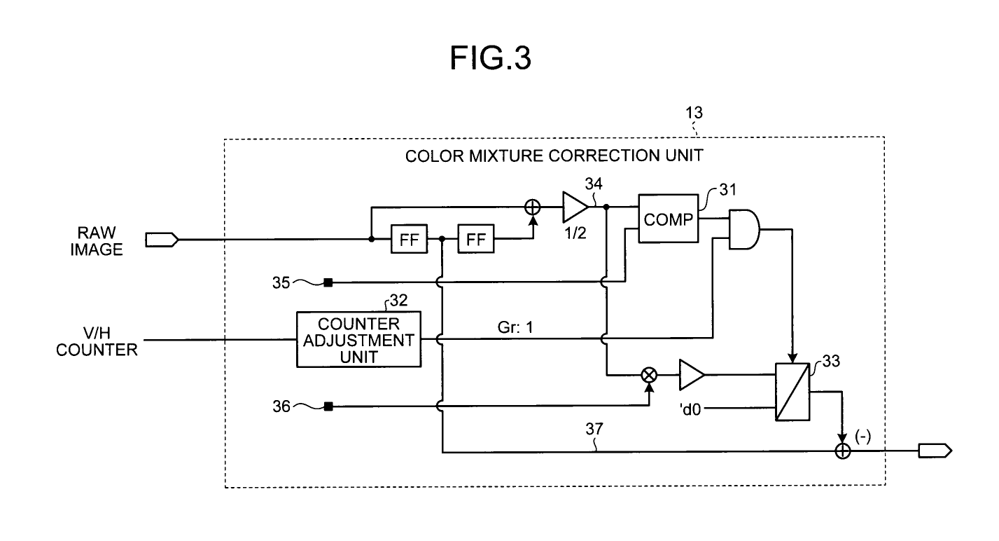

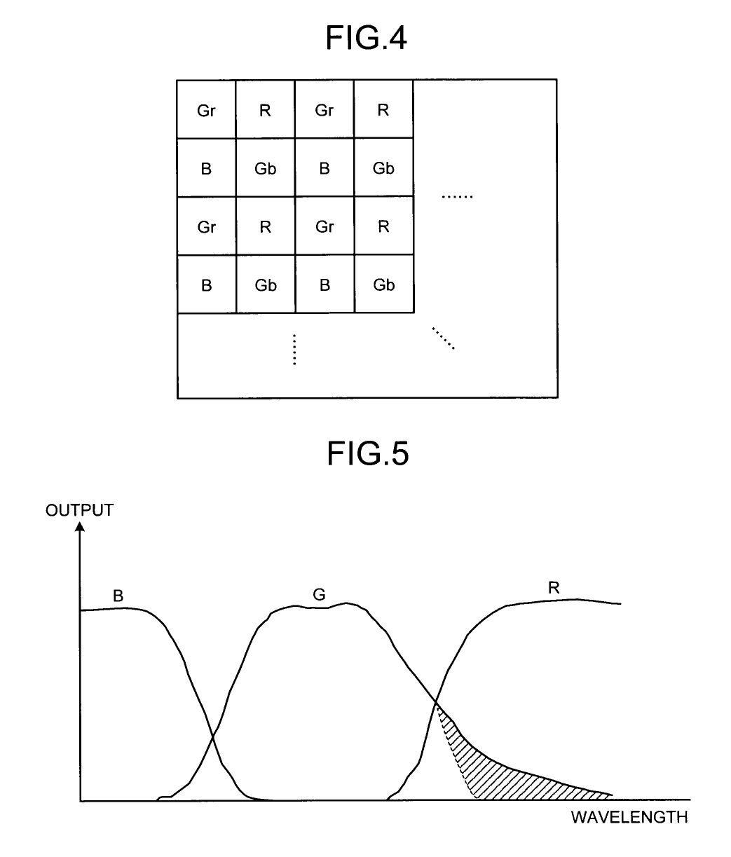

FIG. 3 is a block diagram showing a configuration of a color mixture correction unit. FIG. 4 is a diagram illustrating the arrangement of pixels. A Gr pixel refers to a G pixel which is arranged in line with the R pixel in the horizontal direction. A Gb pixel refers to a G pixel which is arranged in line with the B pixel in the horizontal direction. The Gr and B pixels are arranged in a line in the vertical direction. The Gb and R pixels are arranged in a line in the vertical direction. The B and R pixels are arranged in a line in a direction oblique to the horizontal and vertical directions.

The color mixture correction unit 13 corrects the mixture of colors caused when an incident light having passed through color filters corresponding to neighboring pixels enters a target pixel by referencing the signal level of the target pixel and the signal levels of the neighboring pixels. The target pixel is a pixel which is subjected to color mixture correction, and is assumed to be the Gr pixel in this example. The neighboring pixels are pixels positioned around the target pixel, and are assumed to be the R pixels in this example.

The color mixture correction unit 13 receives RAW image data line by line (Gr/R line and Gb/B line). Flip-flops (FFs) hold the signal levels of pixels. The color mixture correction unit 13 holds the signals of two pixels using two FFs and synchronizes the signals of the target pixel and the neighboring pixels.

In the present embodiment, the color mixture correction unit 13 uses a Gr pixel located at the center of three pixels arranged in a line in the horizontal direction as the target pixel and performs color mixture correction using the R pixels located on the left and right sides of the target pixel as the neighboring pixels. The color mixture correction unit 13 references the signal levels of the R pixels arranged in a line in one-dimensional direction in the sensor unit 3.

The color mixture correction unit 13 includes a comparator (COMP) 31, a counter adjustment unit 32, and a selector 33. The color mixture correction unit 13 holds an R threshold 35 and a correction coefficient 36 which are set in advance. The COMP 31 compares the average 34 of the signal levels of the two R pixels which are the neighboring pixels with the R threshold 35. The average 34 is the arithmetic average, for example.

If the relation of (average 34)>(R threshold 35) is satisfied, the COMP 31 outputs “1”, for example. If the relation of (average 34)>(R threshold 35) is not satisfied, the COMP 31 outputs “0”, for example.

The counter adjustment unit 32 determines the color of a pixel located at the center of the three pixels arrange in a line in the horizontal direction in accordance with a V/H counter. The counter adjustment unit 32 outputs “1” when the Gr pixel is at the center of the three pixels arranged in a line in the horizontal direction and outputs “0” in other cases. When the central pixel is the Gr pixel, and the relation of (average 34)>(R threshold 35) is satisfied, the selector 33 selects a correction amount which is the product of the correction coefficient 36 and the average 34.

The color mixture correction unit 13 outputs a value obtained by subtracting the correction amount selected by the selector 33 from the signal level 37 of the Gr pixel which is the target pixel. In this way, when the signal level of the R pixel which is the neighboring pixel is greater than the R threshold 35, the color mixture correction unit 13 subtracts the correction amount calculated based on the signal level of the R pixel from the signal level 37 of the Gr pixel which is the target pixel.

When the central pixel is the Gr pixel, and the relation of (average 34)>(R threshold 35) is not satisfied, the selector 33 selects ‘d0. In this case, the color mixture correction unit 13 outputs the signal level 37 of the Gr pixel as it is. Even when the central pixel is a pixel other than the Gr pixel, the color mixture correction unit 13 outputs the signal level of that pixel as it is if the selector 33 selects ‘d0.

FIG. 5 is a diagram illustrating mixture of colors. In the case of a single-chip solid-state imaging device, the mixture of colors is likely to occur in which the signal of a pixel (for example, an R pixel) of a color of which the wavelength is the longest among colors enters a pixel (for example, a G pixel) of any of other colors. When the signal of the R pixel is superimposed on the signal of the G pixel, the skirt portion of the output of the G pixel overlapping the output of the R pixel is spread toward the longer wavelength side more than the original output depicted by the broken line in the drawing. As a result, superimposition of signals due to the mixture of colors occurs as depicted by the hatched line in the drawings.

In the case of the Bayer arrangement, since a signal superimposition level in the Gr pixel positioned near the R pixel is different from that of the Gb pixel positioned near the B pixel, the output level of the Gr pixel may differ from the output level of the Gb pixel. Such a difference in the output level may cause a grid-like noise pattern when the output signal is subjected to image processing such as demosaic processing.

The color mixture correction unit 13 can correct the difference in the superimposition level with high accuracy by changing the correction amount applied to the Gr pixel in accordance with the signal level of the R pixel. The DSP 1 can suppress the effect of color mixture effectively by using the color mixture correction unit 13.

The color mixture correction unit 13 is not limited to a case in which the correction amount having a linear property in relation to the signal level of the R pixel which is the neighboring pixel is applied to the target pixel. The color mixture correction unit 13 may apply a correction amount having a non-linear property in relation to the signal level of the R pixel which is the neighboring pixel to the target pixel.

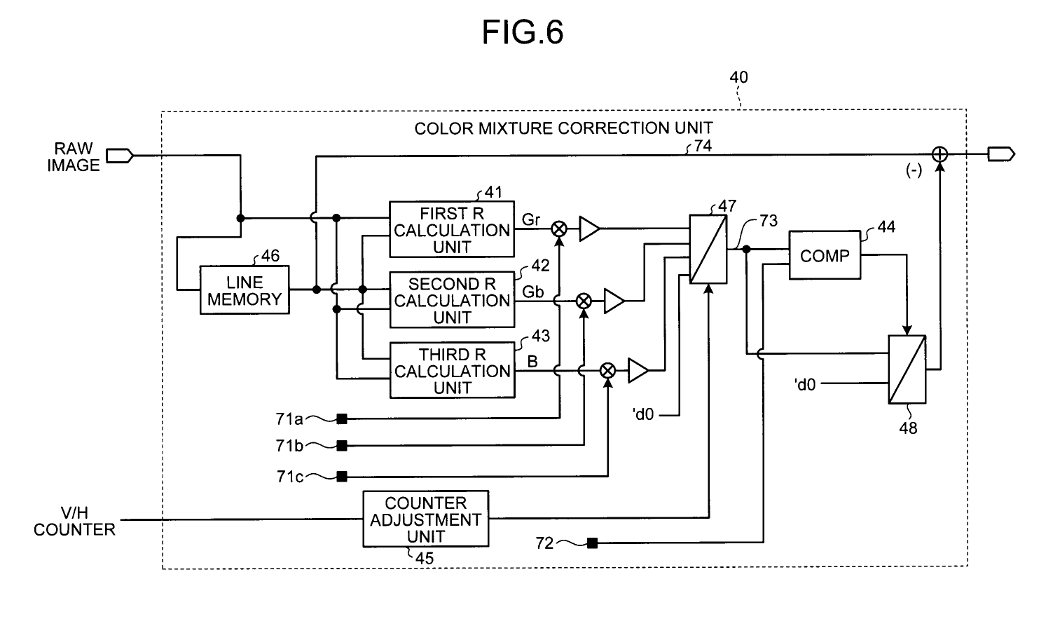

FIG. 6 is a block diagram showing a configuration of a color mixture correction unit used in an image processing apparatus according to a second embodiment. A color mixture correction unit 40 of the present embodiment performs color mixture correction by referencing the signal levels of R pixels arranged in line with a target pixel in two-dimensional directions. The same portions as the first embodiment will be denoted by the same reference numerals, and a description thereof will be repeated.

The color mixture correction unit 40 includes three R calculation units 41, 42, and 43, and a comparator (COMP) 44, a counter adjustment unit 45, a line memory 46, and selectors 47 and 48. The color mixture correction unit 40 holds correction coefficients 71a, 71b, and 71c and an R threshold 72 which are set in advance.

The line memory 46 holds signals of two lines and applies a delay (line delay) in the vertical direction. In the present embodiment, the target pixel is positioned at the center of 9 pixels that form a 3-by-3 pixel matrix. The neighboring pixels are 8 pixels positioned around the target pixel.

As shown in FIG. 4, the Gr and R pixels are alternately arranged in a line in the horizontal direction. The first R calculation unit 41 calculates the average of the signal levels of two R pixels adjacent to the Gr pixel used as the target pixel in the horizontal direction.

The Gr and R pixels are alternately arranged in a line in the vertical direction. The second R calculation unit 42 calculates the average of the signal levels of two R pixels adjacent to the Gb pixel used as the target pixel in the vertical direction.

The B and R pixels are alternately arranged in a line in a direction oblique to the horizontal and vertical directions. The third R calculation unit 43 calculates the average of the signal levels of four R pixels adjacent to the B pixel used as the target pixel in the oblique direction. Each of the first, second, and third calculation units 41, 42, and 43 calculate the arithmetic average as the average, for example.

The counter adjustment unit 45 determines the color of a pixel located at the center of the 9 pixels in accordance with a V/H counter. The selector 47 selects a value in accordance with the output of the counter adjustment unit 45.

When the Gr pixel is at the center of the matrix, the selector 47 selects a correction amount using the product of the average calculated by the first R calculation unit 41 and the correction coefficient 71a. When the Gb pixel is at the center of the matrix, the selector 47 selects a correction amount using the product of the average calculated by the second R calculation unit 42 and the correction coefficient 71b. When the B pixel is at the center of the matrix, the selector 47 selects a correction amount using the product of the average calculated by the third R calculation unit 43 and the correction coefficient 71c. The selector 47 selects ‘d0 when the R pixel is at the center of the matrix.

The correction coefficients 71a, 71b, and 71c are appropriately set, for example, in accordance with a difference in the amount of superimposition for each color which occurs depending on the wiring state or the like of the image sensor 3.

The COMP 44 compares an output value 73 which is the correction amount selected by the selector 47 with an R threshold 72. The selector 48 selects one of the output value 73 of the selector 47 and ‘d0 in accordance with the comparison result of the COMP 44. When the relation of (output value 73)>(R threshold 72) is satisfied, the selector 48 selects the output value 73.

The color mixture correction unit 40 outputs a value obtained by subtracting the value selected by the selector 48 from the signal level 74 of the target pixel. In this way, when the signal level of the R pixel, the neighboring pixel, is greater than the R threshold 72, the color mixture correction unit 40 subtracts the correction amount calculated in accordance with the signal level of the R pixel from the signal level 74 of the Gr, Gb, or B pixel which is the target pixel.

When the relation of (output value 73)>(R threshold 72) is not satisfied, the selector 48 selects ‘d0. In this case, the color mixture correction unit 40 outputs the signal level 74 of the target pixel as it is. When the R pixel which is not the correction target is at the center of the matrix, the selector 48 selects ‘d0, and thus, the color mixture correction unit 40 outputs the signal level of the R pixel as it is.

The color mixture correction unit 40 can correct the difference in the superimposition level with high accuracy by changing the correction amount applied to the target pixel in accordance with the signal level of the R pixel. Moreover, the color mixture correction unit 40 can perform color mixture correction with respect to the Gr, Gb, and B pixels by referencing the signal level of the R pixel arranged in line with the target pixel in two-dimensional directions. The DSP 1 can suppress the effect of the color mixture effectively by using the color mixture correction unit 40.

The use of the color mixture correction unit 40 is not limited to a case in which all of the Gr, Gb, and B pixels are subjected to color mixture correction. The color mixture correction unit 40 may perform color mixture correction with respect to at least one of the Gr, Gb, and B pixels.

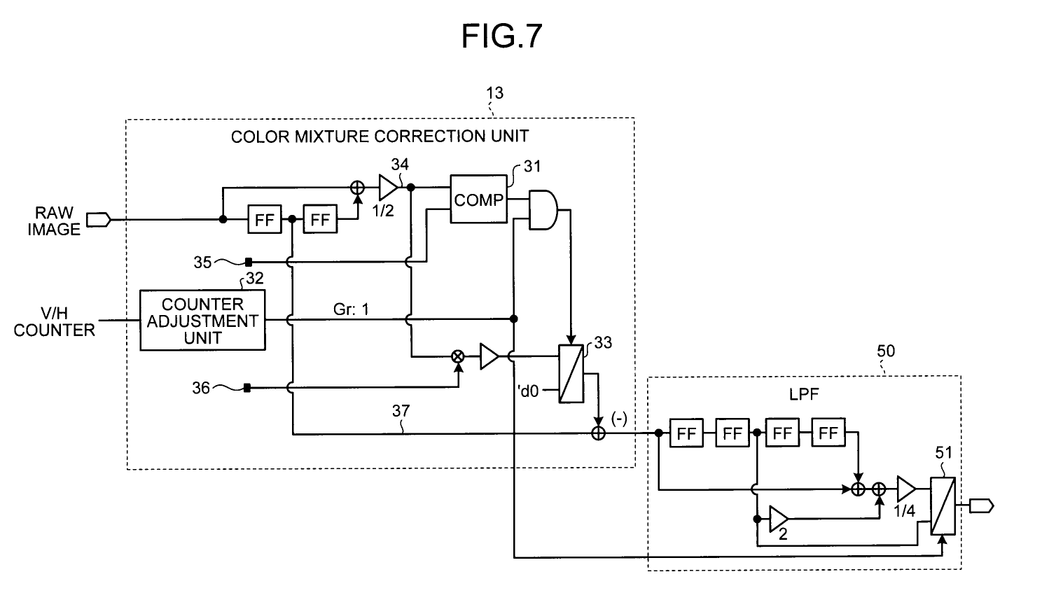

FIG. 7 is a block diagram showing a configuration of a color mixture correction unit and a low-pass filter which are used in an image processing apparatus according to a third embodiment. The same portions as the above embodiments will be denoted by the same reference numerals, and the description thereof will be repeated. A low-pass filter (LPF) 50 serves as a planarization processing unit that performs a planarization process with respect to signals which have been subjected to subtraction of the correction amount by the color mixture correction unit 13.

The LPF 50 holds signals of four pixels using four FFs. The LPF 50 planarizes the signal levels of a Gr pixel used as a target pixel and two Gr pixels located before and after the central Gr pixel among five pixels arranged in a line in the horizontal direction. The planarization process is realized, for example, by a calculation in which the signal level of the Gr pixel used as the target pixel is doubled and added to the values of the signal levels of the two Gr pixels, and the result of addition is divided by 4. The planarization process may be performed by any method and may be appropriately modified.

A selector 51 determines whether the Gr pixel is at the center of the five pixels arranged in a line in the horizontal direction in accordance with the output from the counter adjustment unit 32 of the color mixture correction unit 13 and selects a value. When the Gr pixels is the central pixel, the LPF 50 causes the value obtained through the planarization process to be selected and output by the selector 51. When the Gr pixel is not the central pixel, the LPF 50 causes the signal level of the central pixel to be selected and output by the selector 51.

The DSP 1 can suppress the influence of errors which is likely to occur through the correction in the color mixture correction unit 13, by using the LPF 50. The LPF 50 may be used together with the color mixture correction unit 40 of the second embodiment as well as being used together with the color mixture correction unit 13 of the first embodiment.

The image processing apparatus according to the first, second, and third embodiments may be applied to electronic apparatuses other than the digital camera, such as, for example, a camera-attached mobile phone.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising a color mixture correction unit that references a signal level of a target pixel among pixels arranged in a solid-state imaging device and a signal level of a neighboring pixel positioned around the target pixel to correct mixture of colors caused when an incident light having passed through a color filter corresponding to a neighboring pixel enters the target pixel,
wherein the color mixture correction unit calculates a correction amount corresponding to the signal level of a red pixel which is the neighboring pixel and performs a calculation on the signal level of the target pixel using the correction amount.

2. The image processing apparatus according to claim 1,
wherein the color mixture correction unit subtracts the correction amount from the signal level of the target pixel when the signal level of the red pixel is greater than a predetermined threshold.

3. The image processing apparatus according to claim 2,
wherein the color mixture correction unit compares an average of the signal levels of a plurality of the red pixels adjacent to the target pixel with the threshold.

4. The image processing apparatus according to claim 1,
wherein the color mixture correction unit references the signal level of the red pixel arranged in line with the target pixel in one-dimensional direction in the solid-state imaging device.

5. The image processing apparatus according to claim 4,
wherein the target pixel is a green pixel adjacent to the red pixel in the one-dimensional direction.

6. The image processing apparatus according to claim 1,
wherein the color mixture correction unit references the signal level of the red pixel arranged in line with the target pixel in two-dimensional directions in the solid-state imaging device.

7. The image processing apparatus according to claim 6,
wherein the target pixel is at least one of a green pixel adjacent to the red pixel in a horizontal direction, a green pixel adjacent to the red pixel in a vertical direction, and a blue pixel adjacent to the red pixel in a direction oblique to the horizontal and vertical directions.

8. The image processing apparatus according to claim 1, further comprising a planarization processing unit that performs a planarization process on signals having been subjected to the calculation which uses the correction amount obtained by the color mixture correction unit.

9. An image processing method comprising:
performing color mixture correction which involves referencing a signal level of a target pixel among pixels arranged in a solid-state imaging device and a signal level of a neighboring pixel positioned around the target pixel to thereby correct mixture of colors caused when an incident light having passed through a color filter corresponding to the neighboring pixel enters the target pixel,
calculating a correction amount corresponding to a signal level of a red pixel which is the neighboring pixel in the color mixture correction and performing a calculation on the signal level of the target pixel using the correction amount.

10. The image processing method according to claim 9,
wherein in the color mixture correction, the correction amount is subtracted from the signal level of the target pixel when the signal level of the red pixel is greater than a predetermined threshold.

11. The image processing method according to claim 9,
wherein in the color mixture correction, the signal level of the red pixel arranged in line with the target pixel in one-dimensional direction in the solid-state imaging device is referenced.

12. The image processing method according to claim 11,
wherein the target pixel is a green pixel adjacent to the red pixel in the one-dimensional direction.

13. The image processing method according to claim 9,
wherein in the color mixture correction, the signal level of the red pixel arranged in line with the target pixel in two-dimensional directions in the solid-state imaging device is referenced.

14. The image processing method according to claim 13,
wherein the target pixel is at least one of a green pixel adjacent to the red pixel in a horizontal direction, a green pixel adjacent to the red pixel in a vertical direction, and a blue pixel adjacent to the red pixel in a direction oblique to the horizontal and vertical directions.

15. The image processing method according to claim 9, further comprising performing a planarization process on signals having been subjected to the calculation which uses the correction amount obtained by the color mixture correction.

16. A camera module comprising:
a lens unit that captures light from a subject;
a solid-state imaging device that generates an image signal corresponding to the light captured by the lens unit; and
an image processing apparatus that performs image processing on the image signal from the solid-state imaging device,
wherein the image processing apparatus includes a color mixture correction unit that references a signal level of a target pixel among pixels arranged in the solid-state imaging device and a signal level of a neighboring pixel positioned around the target pixel to correct mixture of colors caused when an incident light having passed through a color filter corresponding to the neighboring pixel enters the target pixel, and
wherein the color mixture correction unit calculates a correction amount corresponding to the signal level of a red pixel which is the neighboring pixel and performs a calculation on the signal level of the target pixel using the correction amount.

17. The camera module according to claim 16,
wherein the color mixture correction unit subtracts the correction amount from the signal level of the target pixel when the signal level of the red pixel is greater than a predetermined threshold.

18. The camera module according to claim 16,
wherein the color mixture correction unit references the signal level of the red pixel arranged in line with the target pixel in one-dimensional direction in the solid-state imaging device.

19. The camera module according to claim 16,
wherein the color mixture correction unit references the signal level of the red pixel arranged in line with the target pixel in two-dimensional directions in the solid-state imaging device.

20. The camera module according to claim 16,
wherein the image processing apparatus further includes a planarization processing unit that performs a planarization process on signals having been subjected to the calculation which uses the correction amount obtained by the color mixture correction unit.
